(19) United States
(12) Patent Application Publication
(10) Pub. No.: US 2022/0012729 A1
(43) Pub. Date: Jan. 13, 2022

(54) System and Method for Managing Accounting and Billing using Blockchain Technology

(71) Applicant: MatchX GmbH, Berlin (DE)

(72) Inventor: Xin Hu, Berlin (DE)

(21) Appl. No.: 17/372,209

(22) Filed: Jul. 9, 2021

Related U.S. Application Data
(60) Provisional application No. 63/050,525, filed on Jul. 10, 2020.

(51) Int. Cl. G06Q 20/38; G06Q 40/02; G06Q 20/10; G06Q 20/40; G06Q 40/00; G06F 16/27

(52) U.S. Cl. CPC G06Q 20/389; G06Q 40/02; G06Q 20/108; G06Q 20/14; G06Q 40/12; G06F 16/27; G06Q 20/4037

(57) ABSTRACT

A system and a method are provided for managing accounting and billing using blockchain technology that reduces fraud and risk, increases transactional trust, lowers transaction costs, and accelerates processing times. The system includes at least one remote server that manages a plurality of user account. Each user account is associated with a corresponding personal computing (PC) device. Each user account is also associated with a user balance. Each user account allows an individual to communicate and interact with the remote server. The corresponding PC device may be any type of computing device such as, but limited, a desktop computer, a notebook computer, a smartphone, or a mobile tablet. The user balance is a digital wallet that manages currency of the user account. The system additionally includes a network of computing nodes that manages a blockchain ledger. The blockchain ledger is a distributed and decentralized ledger that records and verifies transactions.

The current application claims a priority to the U.S. Provisional Patent application Ser. No. 63/050,525 filed on Jul. 10, 2020.

### FIELD OF THE INVENTION

The present invention relates generally to accounting and billing systems and methods. More specifically, the present invention is a system and method for managing accounting and billing using blockchain technology that reduces fraud and risk, increases transactional trust, lowers transaction costs, and accelerates processing times.

### BACKGROUND OF THE INVENTION

Internet of things (IoT) refers to a system of interconnected devices that communicate with each other and exchange data without the need of any human intervention. IoT is used in various methods where users communicate and interact with each other through applications. There is always some risk and delay in the interaction with a software application through conventional methods. There exists a need for a new system and method that reduces fraud and risk, increases transactional trust, lowers transaction costs, and accelerates processing times.

The present invention provides a system and method for managing accounting and billing using blockchain technology. IoT used with blockchain technology to automate the process of accounting and billing improves its overall productivity. The inherent attributes of blockchain technology like distributed ledgers, decentralized databases, the elimination of third-party intermediaries, high-quality encrypted/notarized transactions and transparency simplifies the process of billing and accounting, as all the ledgers are connected; transactions are recorded, sorted, and verified in real-time; and the status of each transaction is trackable. Integrating blockchain into accounting operations through IoT can reduce fraud and risk, increase transactional trust, lower transaction costs, and accelerate processing times.

### BRIEF DESCRIPTION OF THE DRAWINGS

FIG. 1 is a diagram illustrating the system of the present invention.

FIG. 2A is a flowchart illustrating the overall process of the present invention.

FIG. 2B is a continuation of FIG. 2A.

FIG. 3 is a flowchart illustrating the subprocess of executing a transaction request as a withdrawal request.

FIG. 4 is a flowchart illustrating the subprocess of executing a transaction request as a deposit request.

FIG. 5 is a flowchart illustrating the subprocess of executing a transaction request as a bill-payment request.

FIG. 6 is a flowchart illustrating the subprocess of executing a transaction request as a user paying an invoice.

FIG. 7 is a flowchart illustrating the subprocess for a user to view his or her user balance.

FIG. 8 is a flowchart illustrating the subprocess for a user to track the status of a transaction request.

### DETAIL DESCRIPTIONS OF THE INVENTION

All illustrations of the drawings are for the purpose of describing selected versions of the present invention and are not intended to limit the scope of the present invention.

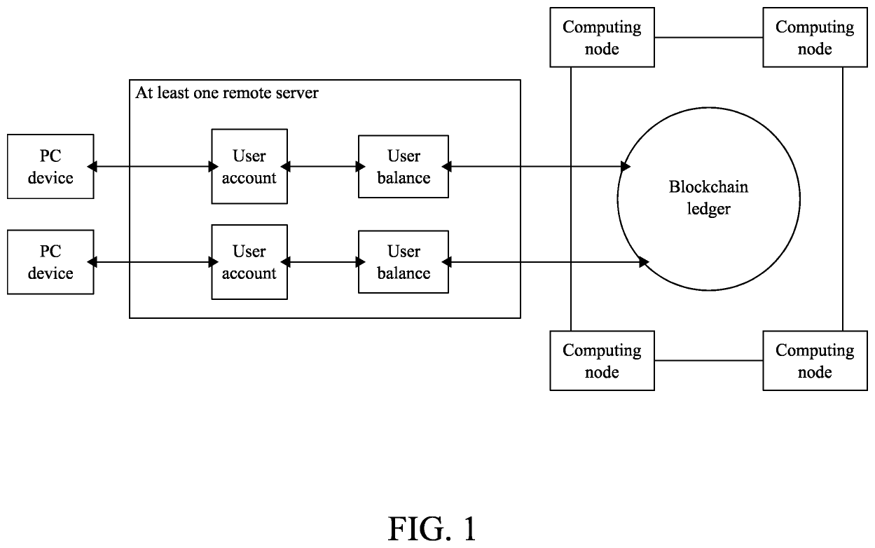

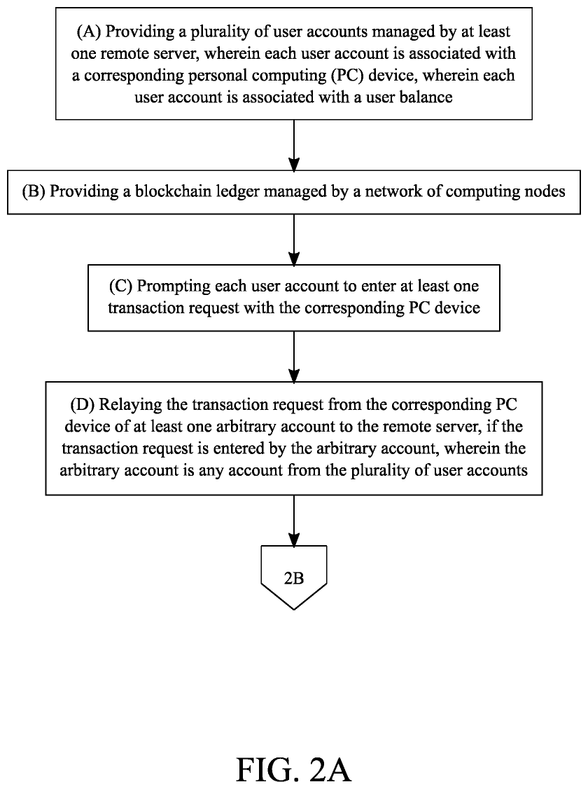

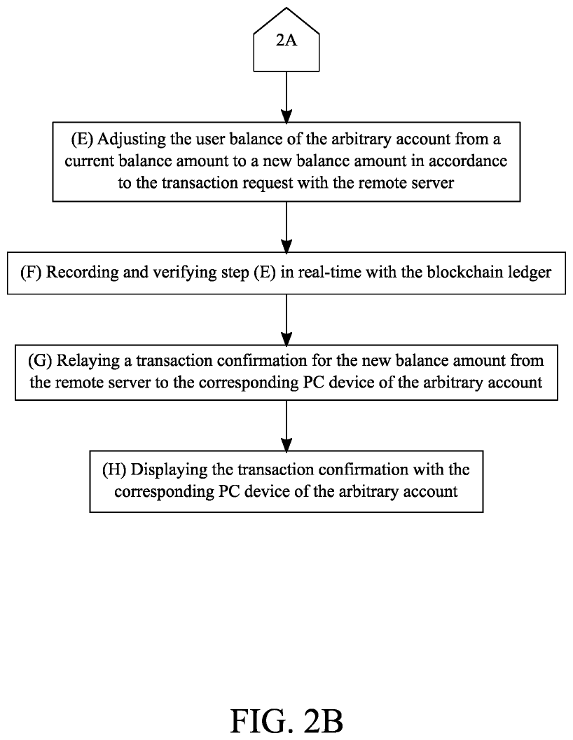

In reference to FIGS. 1 through 8, the present invention is a system and method for managing accounting and billing using blockchain technology that reduces fraud and risk, increases transactional trust, lowers transaction costs, and accelerates processing times. With reference to FIGS. 1 and 2A, the system of the present invention includes at least one remote server that manages a plurality of user accounts (Step A). Each user account is associated with a corresponding personal computing (PC) device. Each user account is also associated with a user balance. Each user account allows an individual to communicate and interact with the remote server. The corresponding PC device may be any type of computing device such as, but not limited to, a desktop computer, a notebook computer, a smartphone, or a mobile tablet. In the case where the PC device is a smartphone or a mobile tablet, users are given access to a mobile version for the software application provided by the present invention. The user balance is a digital currency storage that manages currency of the user account. The system of the present invention additionally includes a network of computing nodes that manages a blockchain ledger (Step B). The blockchain ledger is a distributed and decentralized ledger that records and verifies transactions.

The method of the present invention follows an overall process that reduces fraud and risk, increases transactional trust, lowers transaction costs, and accelerates processing times. With reference to FIG. 2A, the corresponding PC device prompts each user account to enter at least one transaction request (Step C). The transaction request may be for any type of transaction such as, but not limited to, depositing currency, withdrawing currency, sending a payment request, or paying an invoice. The transaction request is relayed from the corresponding PC device of at least one arbitrary account to the remote server, if the transaction request is entered by the arbitrary account (Step D). The arbitrary account is any account from the plurality of user accounts. Step D provides instructions to the remote server to process the transaction request. With reference to FIG. 2B, the remote server adjusts the user balance of the arbitrary account from a current balance amount to a new balance amount in accordance to the transaction request (Step E). In more detail, based on the instructions provided to the remote server, the remote server increases or decreases the user balance of the arbitrary account. The blockchain ledger records and verifies Step E in real-time (Step F). Step F is executed in order to prevent fraud and risk and increase the transactional trust for the user accounts interacting with the remote server. Once the transaction is verified by the blockchain ledger, the network of computing nodes notifies the remote server, and the remote server generates a transaction confirmation. The remote server then relays the transaction confirmation for the new balance amount to the corresponding PC device of the arbitrary account (Step G). The transaction confirmation is a receipt of the processed transaction along with an updated statement for the user balance of the arbitrary account. The corresponding PC device of the arbitrary account displays the transaction confirmation (Step H). The transaction confirmation is preferably a page of information that includes the receipt for the processed transaction and the current user balance.

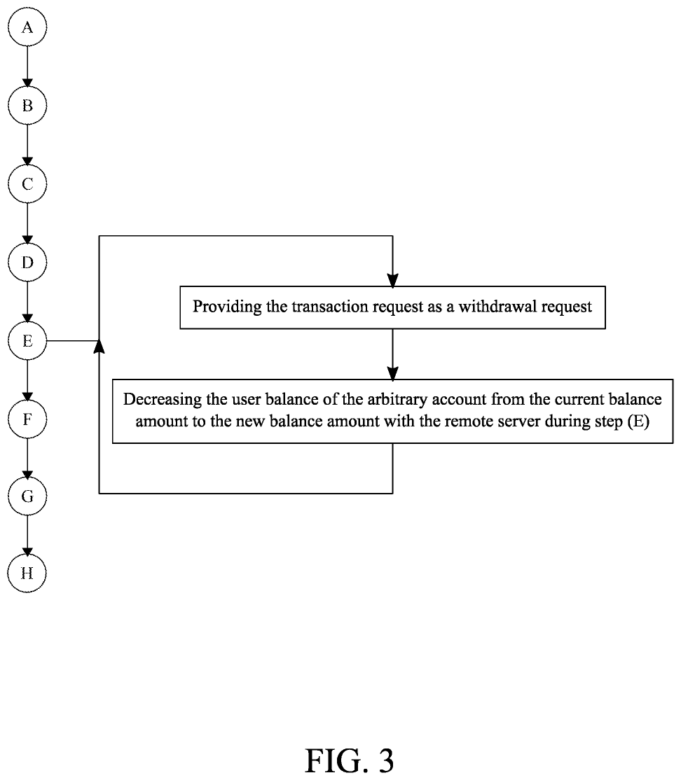

As mentioned previously, the transaction request may be for any type of transaction. If the user desires to withdraw currency and with reference to FIG. 3, the following subprocess is executed. The transaction request is provided as a withdrawal request. In more detail, the user account can choose from a list of options wherein the withdrawal request is one of the options. The remote server decreases the user balance of the arbitrary account from the current balance to the new balance amount during Step E. Thus, currency is withdrawn from the user balance and is outputted to the user.

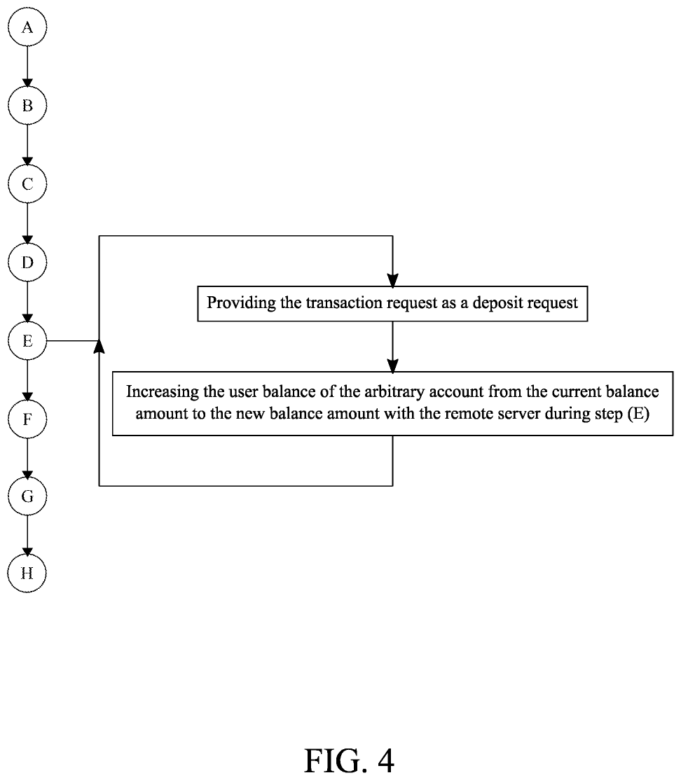

Alternatively, if the user desires to deposit currency and with reference to FIG. 4, the following subprocess is executed. The transaction request is provided as a deposit request. In more detail, the user account chooses the deposit request from a list of options. The remote server increases the user balance of the arbitrary account from the current balance to the new balance amount during Step E. Thus, currency is deposited into the user balance.

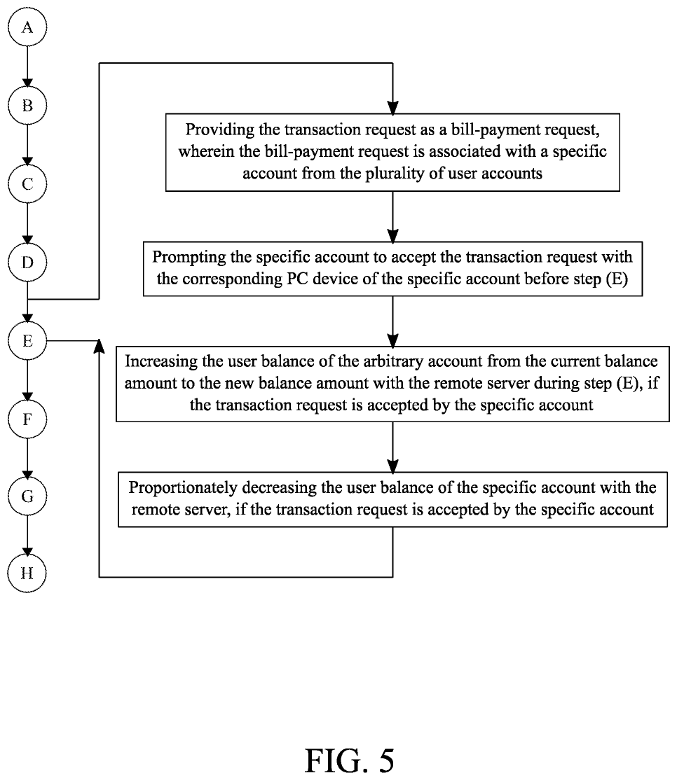

In order for a user to bill another user and with reference to FIG. 5, the following subprocess is executed. The transaction request is provided as a bill-payment request, wherein the bill-payment request is associated with a specific account from the plurality of user accounts. In more detail, the arbitrary account chooses the bill-payment request from a list of options and additionally enters the specific account to associate the specific account with the bill-payment request. The corresponding PC device of the specific account prompts the specific account to accept the transaction request before Step E. This step provides the specific account the option to accept the transaction request if the transaction request is accurate and legitimate. If the transaction request is not accurate and/or legitimate, the specific account can also decline the transaction request or send an adjustment for the transaction request to the arbitrary account. The remote server increases the user balance of the arbitrary account from the current balance amount to the new balance amount during Step E, if the transaction request is accepted by the specific account. Thus, the arbitrary account is successfully compensated after billing the specific account. Simultaneously, the remote server proportionately decreases the user balance of the specific account, if the transaction request is accepted by the specific account. Thus, the specific account successfully pays the bill sent from the arbitrary account.

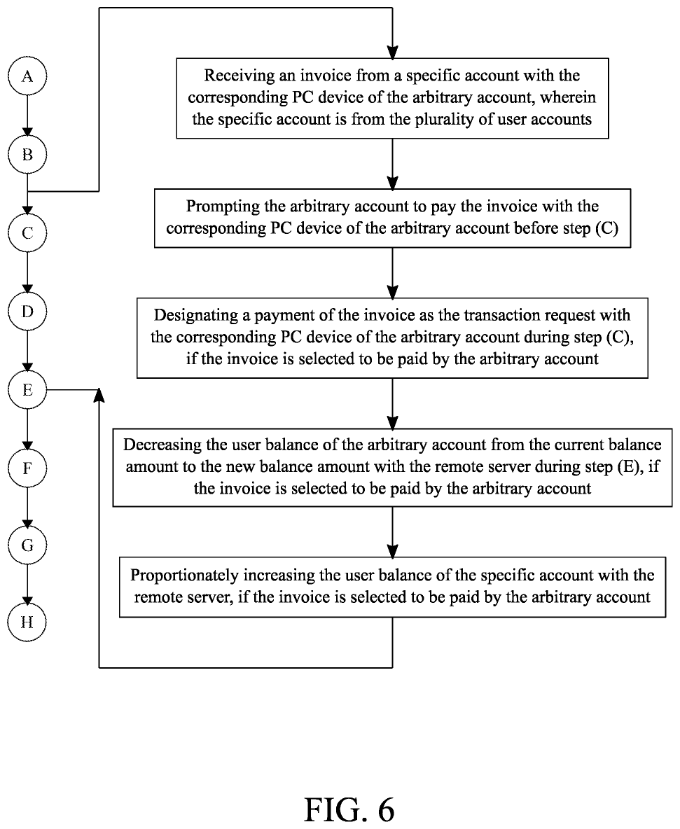

Alternatively, in order for a user to pay a bill sent from another user and with reference to FIG. 6, the following subprocess is executed. The corresponding PC device of the arbitrary account receives an invoice from a specific account. The invoice is a bill for a purchased object or service provided by the specific account. The corresponding PC device of the arbitrary account prompts the arbitrary account to pay the invoice before Step C. This step provides the arbitrary account the option to accept the invoice if the invoice is accurate and legitimate. If the invoice is not accurate and/or legitimate, the arbitrary account can also decline the invoice or send an adjustment for the invoice to the specific account. The corresponding PC device of the arbitrary account designates a payment of the invoice as the transaction request during Step C, if the invoice is selected to be paid by the arbitrary account. In more detail, once the arbitrary account accepts to pay the invoice, the arbitrary account can initiate a transaction request in order to complete payment of the invoice. The remote server decreases the user balance of the arbitrary account from the current balance amount to the new balance amount during Step E, if the invoice is selected to be paid by the arbitrary account. Thus, the arbitrary account successfully pays the bill sent by the specific account. Simultaneously, the remote server proportionately increases the user balance of the specific account, if the invoice is selected to be paid by the arbitrary account. Thus, the specific account is successfully compensated after billing the arbitrary account.

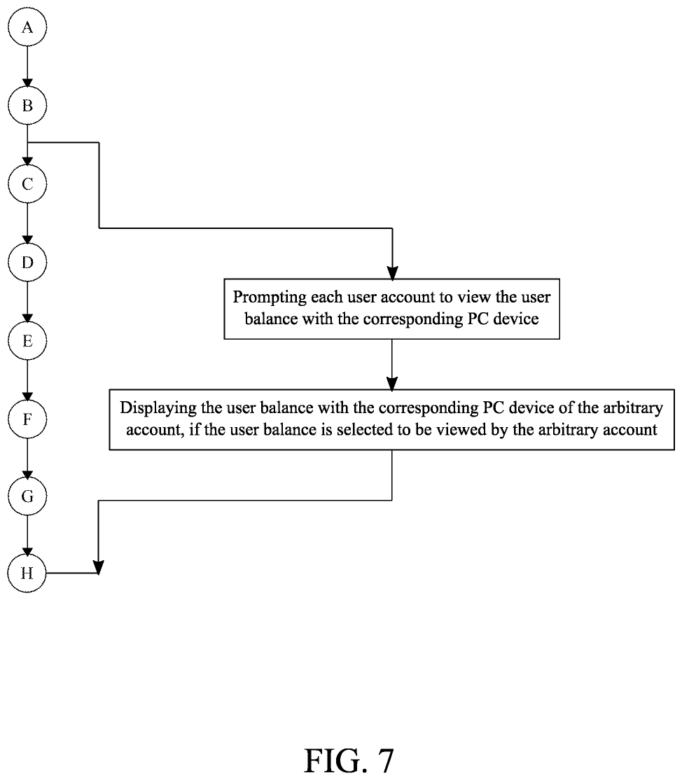

In order for a user to view his or her user balance when desired and with reference to FIG. 7, the following subprocess is executed. The corresponding PC device prompts each user account to view the user balance. In more detail, the user interface provided by the remote server includes an option for a user to view his or her user balance. The corresponding PC device of the arbitrary account displays the user balance, if the user balance is selected to be viewed by the arbitrary account. The user balance can be displayed as a page of information that includes all the transactions made by the arbitrary account and the current balance amount.

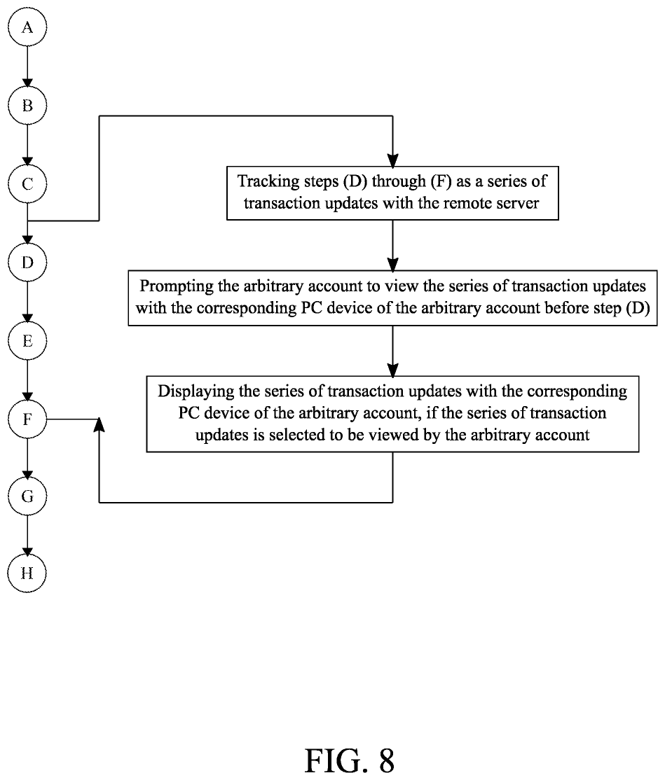

In order for a user to track the status of a transaction in real-time and with reference to FIG. 8, the following subprocess is executed. The remote server tracks Steps D through F as a series of transaction updates. In more detail, the remote server continuously monitors the status of all initiated transactions. The series of transaction updates include status updates ranging from the initiation of a transaction request to the completion of the transaction request. The corresponding PC device of the arbitrary account prompts the arbitrary account to view the series of transaction updates before Step D. In more detail, after the arbitrary account has initiated the transaction request, the arbitrary account is provided the option to track the status of the transaction request. The corresponding PC device of the arbitrary account displays the series of transaction updates, if the series of transaction updates is selected to be viewed by the arbitrary account. Thus, the user is able to track the status of a transaction in real-time.

Although the invention has been explained in relation to its preferred embodiment, it is to be understood that many other possible modifications and variations can be made without departing from the spirit and scope of the invention as hereinafter claimed.

What is claimed is:

1. A method for managing accounting and billing using blockchain technology, the method comprising the steps of:
(A) providing a plurality of user accounts managed by at least one remote server, wherein each user account is associated with a corresponding personal computing (PC) device, wherein each user account is associated with a user balance;
(B) providing a blockchain ledger managed by a network of computing nodes;
(C) prompting each user account to enter at least one transaction request with the corresponding PC device;
(D) relaying the transaction request from the corresponding PC device of at least one arbitrary account to the remote server, if the transaction request is entered by the arbitrary account, wherein the arbitrary account is any account from the plurality of user accounts;
(E) adjusting the user balance of the arbitrary account from a current balance amount to a new balance amount in accordance to the transaction request with the remote server;
(F) recording and verifying step (E) in real-time with the blockchain ledger;
(G) relaying a transaction confirmation for the new balance amount from the remote server to the corresponding PC device of the arbitrary account; and
(H) displaying the transaction confirmation with the corresponding PC device of the arbitrary account.

2. The method for managing accounting and billing using blockchain technology, the method as claimed in claim 1 comprising the steps of:
providing the transaction request as a withdrawal request; and
decreasing the user balance of the arbitrary account from the current balance amount to the new balance amount with the remote server during step (E).

3. The method for managing accounting and billing using blockchain technology, the method as claimed in claim 1 comprising the steps of:
providing the transaction request as a deposit request; and
increasing the user balance of the arbitrary account from the current balance amount to the new balance amount with the remote server during step (E).

4. The method for managing accounting and billing using blockchain technology, the method as claimed in claim 1 comprising the steps of:
providing the transaction request as a bill-payment request, wherein the bill-payment request is associated with a specific account from the plurality of user accounts;
prompting the specific account to accept the transaction request with the corresponding PC device before step (E);
increasing the user balance of the arbitrary account from the current balance amount to the new balance amount with the remote server during step (E), if the transaction request is accepted by the specific account; and
proportionately decreasing the user balance of the specific account with the remote server, if the transaction request is accepted by the specific account.

5. The method for managing accounting and billing using blockchain technology, the method as claimed in claim 1 comprising the steps of:
receiving an invoice from a specific account with the corresponding PC device of the arbitrary account, wherein the specific account is from the plurality of user accounts;
prompting the arbitrary account to pay the invoice with the corresponding PC device before step (C);
designating a payment of the invoice as the transaction request with the corresponding PC device of the arbitrary account during step (C), if the invoice is selected to be paid by the arbitrary account;
decreasing the user balance of the arbitrary account from the current balance amount to the new balance amount with the remote server during step (E), if the invoice is selected to be paid by the arbitrary account; and
proportionately increasing the user balance of the specific account with the remote server, if the invoice is selected to be paid by the arbitrary account.

6. The method for managing accounting and billing using blockchain technology, the method as claimed in claim 1 comprising the steps of:
prompting each user account to view the user balance with the corresponding PC device; and
displaying the user balance with the corresponding PC device of the arbitrary user account, if the user balance is selected to be viewed by the arbitrary account.

7. The method for managing accounting and billing using blockchain technology, the method as claimed in claim 1 comprising the steps of:
tracking steps (D) through (F) as a series of transaction updates with the remote server;
prompting the arbitrary account to view the series of transaction updates with the corresponding PC device before step (D); and
displaying the series of transaction updates with the corresponding PC device of the arbitrary account, if the series of transaction updates is selected to be viewed by the arbitrary account.
